(19) United States
(12) Patent Application Publication
(10) Pub. No.: US 2015/0210595 A1
(43) Pub. Date: Jul. 30, 2015

(54) FILLER FOR CONSTRUCTION

(71) Applicant: Kaneko Concrete Co., Ltd., Kanagawa (JP)

(72) Inventors: Yoshinori Iida, Kanagawa (JP); Keisuke Kaneko, Kanagawa (JP)

(21) Appl. No.: 14/419,528

(22) PCT Filed: Aug. 5, 2013
(86) PCT No.: PCT/JP2013/071122

§ 371 Date: Feb. 4, 2015

(30) Foreign Application Priority Data
Aug. 8, 2012 (JP) 2012-176190

(51) Int. Cl. C04B 18/10; C04B 18/06; C04B 18/04; C04B 18/08

(52) U.S. Cl. CPC C04B 18/103; C04B 18/08; C04B 18/067; C04B 18/10; C04B 18/0418

(57) ABSTRACT

A filler for construction includes a hardening material, a fine powder as an admixture material, and sludge water obtained by separating sand and gravel from discharged water provided by washing concrete handling equipment.

### TECHNICAL FIELD

The present invention relates to a filler for construction.

### BACKGROUND ART

In construction work such as underground railway construction or cable burying construction, it is necessary to backfill a drilled site after construction is completed. For this backfill construction, a construction waste soil that is generally generated for drilling construction has conventionally been used as a backfill material. Then, compaction has to be executed by using a rolling machine every 50 cm backfilling with a waste soil in conventional backfill construction that uses a construction waste soil. Furthermore, in a wide place where it is possible for a heavy machine such as a dump truck to enter, backfill construction that uses a construction waste soil is executed by using such a heavy machine. Furthermore, in a narrow place where it is not possible for such a heavy machine to enter, a construction waste soil is conveyed by human power to execute it.

In a case where backfill construction is executed by using a heavy machine such as a dump truck, a disadvantage is involved such as, for example, an intense noise being caused or a large amount of dust or dirt being generated. Furthermore, in a case where backfill construction is executed by human power, a disadvantage is caused such as extension of a time period for construction or cost increase. In this respect, a construction waste soil is not necessarily optimum as a backfill material for construction work.

It is possible to resolve a drawback involved by providing a construction waste soil as a backfill material as described above, by, for example, providing such a backfill material with an appropriate fluidity. That is, if a backfill material has an appropriate fluidity, it is possible to convey such a backfill material by pumping thereof. As a backfill material is conveyed by pumping thereof, generation of an intense noise or generation of a large amount of dust or dirt is prevented and it is possible to convey a backfill material to even a place with a narrow work space without relying on human power.

Conventionally, for example, Man-Made Soil (registered trademark) available from T. I. C. Co., Ltd. has been known as a backfill material that has fluidity. Man-Made Soil (registered trademark) is a material prepared in such a manner that a cement or water is added to a construction waste soil to exhibit an appropriate fluidity. Therefore, as backfill work is executed by using Man-Made Soil (registered trademark), an amount of generation of noise and dust or dirt is suppressed and further it is possible to execute backfill construction with an excellent workability regardless of a wide or narrow work space.

However, a conventional backfill material as described above, namely, Man-Made soil (registered trademark) is such that a construction waste soil is used as an aggregate. Therefore, a construction waste soil as a material has to be supplied to a plant for preparation in a process for preparing Man-Made Soil (registered trademark).

Furthermore, sand with a large particle size may be mixed and present in such a construction waste soil. If sand with a large particle size is included in a backfill material, the sand with a large particle size is separated from other components due to specific gravity difference after a drilled site is filled with such a backfill material and until the backfill material is hardened, and is a cause for causing sedimentation at a backfilled site.

The applicant for the present application has already proposed a filler for construction work wherein it is possible to resolve a disadvantage as described above (see Patent Document 1).

A filler for construction work as described above is such that a cement is compounded with sand as a fine aggregate and further compounded with concentrated sludge water as a microscopic aggregate provided by concentrating sludge water that is generated by washing concrete handling equipment.

A freshly-mixed concrete used for construction work is generally prepared in a freshly-mixed concrete plant and subsequently conveyed to a construction site by an agitator truck (mixer truck), and after the freshly-mixed concrete is discharged to the construction site, a cement, sand, gravel, and the like, that remain in a loading space of the agitator truck are washed out in a dedicated car wash station. Herein, sludge water that includes a cement component, sand, and gravel are included in discharged water produced by car washing.

Conventionally, sludge water included in discharged water has been disposed of as a non-reusable industrial waste. However, the applicant for the present application found a filler for construction work that is capable of being conveniently manufactured in a general freshly-mixed concrete plant and is capable of readily maintaining a stable quality, wherein sludge water is a raw material of a filler for construction work.

### PRIOR ART DOCUMENTS

### Patent Documents

[Patent Document 1] Japanese Patent No. 2911412 official gazette

### SUMMARY OF THE INVENTION

### Problems to be Solved by the Invention

However, there is a problem of labor or cost for concentrating sludge water in an invention disclosed in Patent Document 1 because such sludge water has to be concentrated and used thereafter.

Furthermore, there is a problem in that it may be difficult to secure concentrated sludge water enough that is concentrated enough to be used because a concentration of sludge water changes depending on a delivery condition of a freshly-mixed concrete.

The present invention is made by talking a problem as described above into consideration, and aims at providing a filler for construction capable of being manufactured by using non-concentrated sludge water.

### Means for Solving the Problem

The present invention provides a filler for construction that includes a hardening material, a fine powder as an admixture material, and sludge water obtained by separating sand and gravel from discharged water provided by washing concrete handling equipment.

### Effects of the Invention

According to the present invention, it is possible to provide a filler for construction capable of being manufactured by using non-concentrated sludge water by adding a fine powder as a admixture material thereto.

Accordingly, it is possible to save labor or energy for concentrating sludge water conventionally. Furthermore, securing of sludge water is facilitated because it is possible to use sludge water regardless of a concentration thereof.

### BRIEF DESCRIPTION OF THE DRAWINGS

FIG. 1 A flow diagram of generation of sludge water in an embodiment of the present invention.

FIG. 2 A diagram that represents an example of use of a filler for construction in an embodiment of the present invention.

### EMBODIMENTS FOR IMPLEMENTING THE INVENTION

Although an embodiment for implementing the present invention will be described below, the present invention is not limited to an embodiment as described below and it is possible to apply a variety of alterations and modifications to an embodiment as described below without departing from the scope of the present invention.

A filler for construction in the present embodiment example is obtained by kneading a hardening material, a fine powder as an admixture material, and sludge water obtained by separating washing and discharged water for concrete handling equipment from sand and gravel.

A hardening material is not particularly limited and it is possible to use each kind of hardening material. For a hardening material, it is possible to use, for example, a cement-type hardening material preferably, and specifically, it is possible to use an ordinary cement, a blast-furnace cement, a high early strength cement, a fly-ash cement, or the like. Among those, it is possible to use a blast-furnace cement B-type preferably, with a preference for convenience of handling thereof, because it is not necessary to harden a filler for construction in the present embodiment example quickly.

A fine powder as an admixture material is, for example, a fine particle with a diameter of about several μm-several hundred μm, wherein its particle size or material (quality of material) is not particularly limited, and it is preferable to be an environmentally friendly fine powder that does not include a cement that reacts with an alkali, water, or the like to develop a strength thereof or the like because addition thereof is made as an admixture material.

Specifically, it is preferable for a fine powder as an admixture material to be, for example, at least one kind selected from a dewatered cake obtained by applying sludge water to a dewatering machine, a fly-ash fine powder, a blast-furnace slag fine powder, an electric furnace slag fine powder, a garbage incineration ash, and a sludge incineration ash. A kind of a fine powder is not limited to one kind, and two or more kinds thereof may be included.

For a fine powder as an admixture material, it is particularly preferable to use a dewatered cake obtained by applying sludge water to a dewatering machine among materials as described above.

This is such that there are not many applications that utilize a dewatered cake obtained from sludge water, in recent years, and a case of being disposed of as an industrial waste has been increased. Accordingly, a dewatered cake is used as a raw material of a filler for construction in the present embodiment so that it is possible to recycle such a material effectively and further it is possible, and hence, preferable, to reduce a waste substance.

It is also possible to add sand to a filler for construction in the present embodiment as described below, and in this case, contents of sand and a fine powder as an admixture material in a filler for construction are not particularly limited, wherein it is possible to be selected by taking a fluidity of an obtained filler for construction or the like into consideration. However, in a case where a ratio of sand is increased so that an amount of added fine powder as an admixture material is too little, there is a possibility of causing plugging of a piping in a case where an obtained filler for construction is pumped by a pump. Accordingly, it is preferable to select contents thereof in such a manner that a content of a fine powder is greater than or equal to 5% by volume of a total amount (total volumetric amount) of sand and the fine powder, that is, in such a manner that a content of a fine powder is greater than or equal to 5% by volume in a case where a total amount of sand and the fine powder is 100% by volume.

It is possible to obtain sludge water by removing sand and gravel from discharged water that is generated by washing equipment used for handling a freshly-mixed concrete, in particular, a loading space of an agitator truck (mixer truck) used for conveyance of a freshly-mixed concrete.

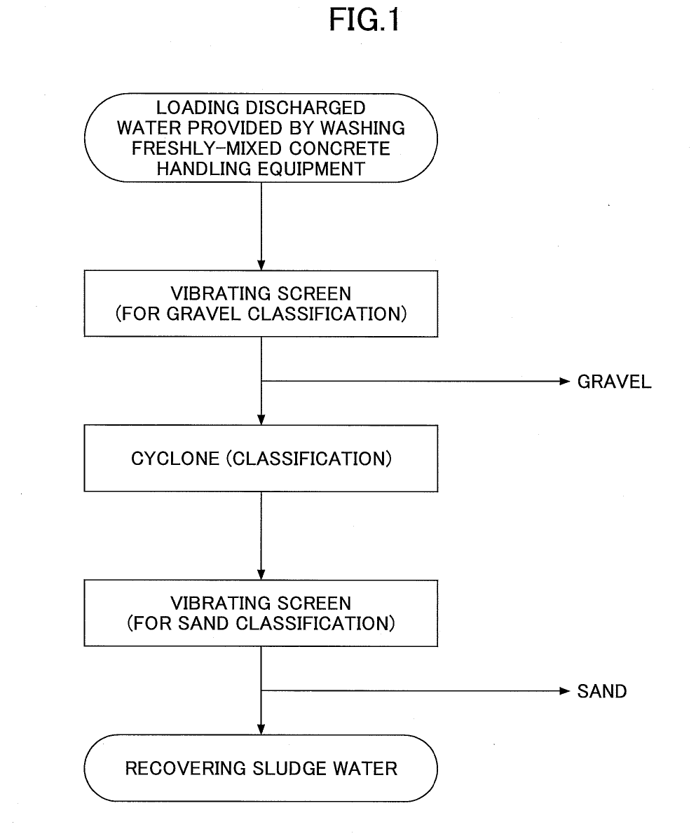

Sludge water is generated by, for example, an operation flow as illustrated in FIG. 1.

First, washing and discharged water from equipment for handling a freshly-mixed concrete (that will also be simply described as “washing and discharged water” below) is loaded into aggregate classification equipment.

First, such washing and discharged water is applied to a vibrating sieve to recover gravel with a large particle size. Then, a water content fallen under the vibrating sieve for recovery of gravel is supplied to a cyclone by a pump to execute classification thereof and subsequently sand is further recovered by a vibrating sieve (one with a mesh finer than a case of classifying gravel).

Then, one passed through a vibrating sieve in this case is recovered as sludge water.

It is possible to obtain sludge water in accordance with a process as described above. Here, without being limited to such an operation, it is possible to use a method that is capable of removing gravel and sand from washing and discharged water to recover sludge water, without being particularly limited.

Conventionally, gravel and sand are recovered and subsequently sludge water is concentrated by a decanter, so that much energy and labor are required for a manufacturing process thereof. However, it is possible for a filler for construction in the present embodiment to simplify a manufacturing process and suppress energy consumption, because it is possible to use non-concentrated sludge water capable of being obtained by a process as described above.

Sludge water obtained by the above process includes a solid content contained in a freshly-mixed concrete (specifically, a cement, a fine sand, a limestone powder, and other dirt components of sand or gravel used as an aggregate of a freshly-mixed concrete) and water.

A concentration of a solid content in obtained sludge water is not particularly limited, and for example, it is preferable to be less than 10% by mass, wherein it is more preferable to be greater than or equal to 1% by mass and less than 10% by mass, wherein it is further preferable to be greater than or equal to 2% by mass and less than 10% by mass, wherein it is particularly preferable to be greater than or equal to 5% by mass and less than 10% by mass. It is possible to use such sludge water directly as a raw material of a filler for construction in the present embodiment.

Here, for example, in a case where an amount of recovered sludge water approaches a limit of a volume of a storage tank or the like, it is also possible to apply sludge water to a dewatering machine to execute a process for separating a dewatered cake and a supernatant fluid. It is possible to use a dewatered cake obtained in this case as a fine powder as an admixture material that is one of raw materials of a filler for construction in the present embodiment as described above. Furthermore, it is possible to recycle a supernatant fluid as water for manufacturing a freshly-mixed concrete.

Although components included in a filler for construction in the present embodiment have been described above, limitation to only these components is not provided and it is also possible to add each kind of additive or the like thereto as necessary.

Furthermore, it is also possible to include sand in as a filler for construction in the present embodiment a component thereof.

For sand, it is possible to use a mountain sand, a river sand, a reconditioned sand, or a pulverized sand, and further, it is also possible to use a blast-furnace slag, a burned slag, or the like, for a portion or an entirety of sand.

Here, a “burned slag” is a granular sand provided by fusing at a high temperature higher than or equal to 1300° C.-1800° C., and throwing into water to be quenched rapidly, a combustion residue (an ash burned ash generated by burning a waste plastic, a food waste, paper waste, an industrial waste such as a wood waste generated at a construction site, or a general garbage such as a burnable garbage in an incineration facility). Furthermore, a “blast-furnace slag” is one produced as a by-product (such as an impurity in an ore) in a case where a pig iron is manufactured and is separated due to a specific gravity difference after being taken at a fused condition together with a pig iron.

A particle size of sand is not particularly limited, and for example, it is preferable for its particle size to be greater than 0 mm and less than or equal to 10 mm, wherein it is more preferable to be greater than and equal to 0.075 mm and less than or equal to 10 mm.

Furthermore, it is preferable for a filler for construction in the present embodiment to further include a hexavalent chromium reducing agent.

This is such that a filler for construction is frequently used to backfill a drilled site after a work is completed in underground railway construction, cable burying construction, or the like, as having been described already.

Because a filler for construction is thus used for an application that fills a drilled site of ground or the like, a filler for construction has a possibility of contacting ground water or the like even in a stage before hardening thereof.

Then, a filler for construction may be such that, for its component, for example, each kind of cement is used as a hardening material, or for example, a garbage incineration ash is used as a fine powder for an admixture material, as described above. Elution of hexavalent chromium is not problematic on a condition that these materials are hardened but a study has not yet sufficiently been executed for pre-hardening thereof. Hence, it is preferable for a filler for construction to contain a hexavalent chromium reducing agent so that it is possible to reduce elution of hexavalent chromium even in a state before a filler for construction is hardened, in order to further reduce a probability of contamination of ground water.

A hexavalent chromium reducing agent is not particularly limited and it is sufficient to suppress elution of hexavalent chromium to water (as compared with a case of no addition thereof) even though a filler for construction contacts water on a condition of non-hardening thereof.

Specifically, it is possible to use, for example, a ferrous sulfate as a hexavalent chromium reducing agent, and among those, it is particularly preferable to use a ferrous sulfate heptahydrate slat (FeSO₄.7H₂O) in that an amount of hydration water is saturated and a property thereof is stable or from the viewpoint of a cost thereof. An amount of addition thereof is not limited and it is sufficient to select an amount of addition thereof so as to be fallen within a required limiting value of an amount of eluted hexavalent chromium.

A ferrous sulfate has a characteristic such that a mass thereof is facilitated to be formed (aggregation thereof is facilitated to be caused) as a water content is absorbed. Then, in a case where a ferrous sulfate with a formed mass is added into a filler for construction in the present invention, it may be difficult to be dissolved in a filler for construction or it may be impossible to be dissolved in a filler for construction depending on a degree of aggregation thereof.

Thus, it is preferable to mix and use a ferrous sulfate with a mix sand in order to prevent a mass of a ferrous sulfate from being produced or to be uniformly dissolved or dispersed in a filler for construction.

It is possible to use a mix sand without being particularly limited, as long as it is possible to penetrate into a space among ferrous sulfates to prevent the ferrous sulfates from aggregating one another. For example, it is preferable to use one or more kinds of sands selected from a mountain sand, a river sand, a reconditioned sand, a pulverized sand, and the like. In particular, in a case where sand is added into a filler for construction, it is preferable to use sand with a kind identical to that of a filler for construction as a mix sand.

A particle size of a mix sand is not particularly limited and it is preferable to have a lot of components with a small particle size because an effect of dispersing a ferrous sulfate is improved. For example, it is preferable to select and use a particle size less than or equal to 2.5 mm by a sieve, wherein it is more preferable to select and use a particle size less than or equal to 1.2 mm by a sieve and it is particularly preferable to select and use a particle size less than or equal to 0.6 mm by a sieve.

A mixing ratio of a mix sand and a ferrous sulfate is not particularly limited and it is sufficient to mix with an amount of a mix sand in such a manner that it is possible to prevent a ferrous sulfate from aggregating. Specifically, for example, in a case where a weight of a ferrous sulfate is 100, it is preferable to mix both of them at a ratio where a weight of a mix sand is within a range of 30 to 100 and it is more preferable to mix both of them at a ratio within a range of 50 to 100.

Here, also in a case where a mix sand and a ferrous sulfate are mixed and used, it is preferable to use a ferrous sulfate heptahydrate salt as a ferrous sulfate due to a reason as described above.

A timing for mixing a mix sand with a ferrous sulfate is not particularly limited, and for example, a ferrous sulfate may preliminarily be mixed with a mix sand and subsequently be stored. Furthermore, a ferrous sulfate and a mix sand may be mixed immediately before addition to a filler for construction. This is because it is possible to mix a mix sand and a ferrous sulfate so that a mass is reduced to attain uniform dispersion in a mix sand even in a case immediately before addition to a filler for construction.

A method for mixing a mix sand and a ferrous sulfate is not particularly limited and it is possible to be mixed (kneaded) by a mixer or each kind of mill.

It is possible to manufacture a filler for construction in the present embodiment as described above by kneading each component as having been described already. A content of each component is not particularly limited and it is possible to be selected based on a required fluidity, a compressive strength at a time of hardening, or the like.

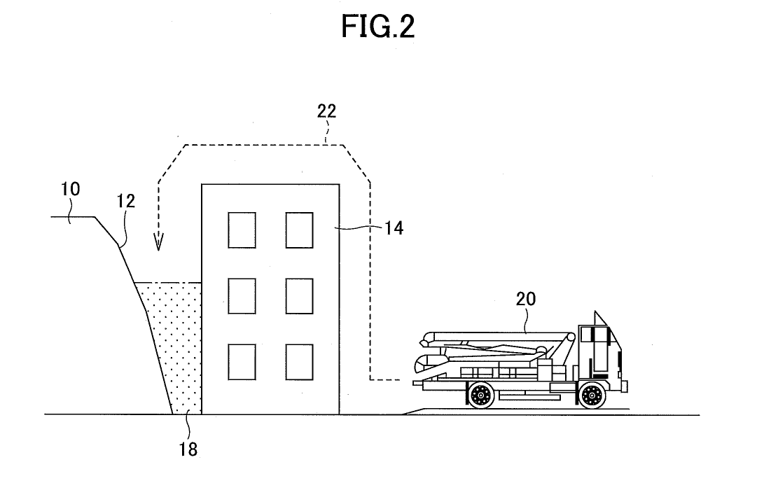

Herein, one example of a type of usage of a filler according to the present embodiment example as described above will be described with reference to FIG. 2.

FIG. 2 illustrates a state where a building 14 is constructed at a position that is slightly away from a slope 12 of a mountain 10.

In a case where the building 14 is constructed at a position that is slightly away from the slope 12 of the mountain 10 as illustrated in FIG. 2, it is necessary to prevent a sediment that slips downward on a slope, from reaching the building 14. Accordingly, a filler 18 fills a space between the slope 12 and the building 14.

At a time of a filling operation, the filler 18 exhibits an appropriate fluidity. If the filler 18 does not exhibit a fluidity, it is necessary to convey the filler 18 to a space between the slope 12 and the building 14 by using a heavy machine such as a crane backhoe or by human power. On the contrary, if the filler 18 exhibits a fluidity like a filler for construction in the present embodiment, it is possible to convey the filler 18 to a space between the slope 12 and the building 14 in a fluid situation.

That is, it is possible to pump the filler 18 to a space between the slope 12 and the building 14 by a pumping truck 20 as illustrated in FIG. 2. Herein, a construction method as illustrated in FIG. 2 is such that the pumping truck 20 for pumping the filler 18 is stopped at an appropriate position near the building 14, then a piping 22 is laid from an ejection port of the pumping truck 20 to a space between the slope 20 and the building 14, and subsequently, a pump of the pumping truck 20 is operated to convey the filler 18.

The filler 18 flown from the piping 22 to a space between the slope 12 and the building 14 slowly spreads from a location of application of the filler 18 to an all space that should be filled with the filler due to a self-fluidity thereof.

Accordingly, it is possible for a construction method in the present embodiment to realize an excellent filling factor without using compaction equipment such as a vibrator. Furthermore, it is possible for a construction method in the present embodiment to fill a space between the slope 12 and the building 14 with the filler 18 at a high working efficiency without causing an intense noise or without generating a large amount of dust or dirt.

Here, it is possible to provide the following aspect as another example of a type of usage of a filler for construction according to the present embodiment example.

For example, in a case where a drilled site is provided in a process for underground railway construction, it is necessary to backfill the drilled site after a necessary work is completed. In such a case, it is possible to use a filler according to the present embodiment example as a backfill material for filling a drilled site. As described above, a filler has an appropriate fluidity at a time of working. Accordingly, it is possible to convey a filler by using an agitator truck similarly to a freshly-mixed concrete.

According to such a construction technique, it is possible to execute backfill of a drilled site at a high working efficiency without causing an intense noise and without generating a large amount of dust and dirt.

Furthermore, for example, in a case where a drilled site is provided in a foundation work for construction of a building, it is necessary to backfill the drilled site after a necessary work is completed. In such a case, it is possible to use a filler according to the present embodiment example as a backfill material for filling a drilled site.

Herein, it is possible to convey a filler to a position just proximal to a drilled site by using an agitator truck similarly to a freshly-mixed concrete. Then, a filler is supplied to an interior of a drilled site through a chute that is installed on an agitator truck.

According to such a construction technique, it is possible to execute backfill for a drilled site at a high working efficiency without causing an intense noise and without generating a large amount of dust and dirt, similarly to a case of a technique as described above.

Furthermore, for example, a concrete wall that corresponds to a room layout of each room is provided on a fundamental part of a single-family house. A concrete wall usually has a ground clearance of about 30 cm. A ground surface surrounded by concrete walls is usually covered with a concrete in order to prevent moisture from reaching a floor surface of a house. In such a case, it is also possible to use a filler according to the present embodiment example a cover material alternative to a concrete.

Herein, a construction work for covering a ground surface by using a filler is such that a filler is conveyed to neighborhood of a construction site by an agitator truck and the filler is supplied to an upper side of a ground surface through a chute and a piping that are installed on the agitator truck.

According to such a construction technique, it is possible to cover a ground surface at a high working efficiency without causing an intense noise and without generating a large amount of dust and dirt.

Meanwhile, it is preferable for a filler for fills a space between a building and a slope or a backfill material used to backfill a drilled site to have an appropriate fluidity as described above, and further, it is preferable for a bleeding rate and a compressive strength to be appropriate values.

A bleeding rate conforms to a standard of the Japan Society of Civil Engineers “A method for testing a bleeding rate and a coefficient of expansion of a grouting mortar of a pre-packed concrete (JSCE-1986)”.

A filler for construction immediately after mixing thereof fills a predetermined polyethylene bag (with a diameter of 5 cm and a length greater than or equal to 50 cm) without being contaminated with air and is put into a measuring cylinder with 400 cc of water contained therein, wherein a water level is caused to coincide with a surface of the filler for construction to obtain an initial volume thereof and a similar measurement is executed after 20 hours of standing thereof to measure a degree of lowering of the water level, so that a bleeding rate is obtained as a proportion relative to the initial volume.

As a bleeding rate is large, a great deal of sedimentation is caused on a surface of a filler for construction (or a backfill material) in a process of hardening thereof. Accordingly, it is preferable for a bleeding rate of a filler or a backfill material to be small.

In an initial process for hardening a filler for construction (or a backfill material), an aggregate with a high specific gravity such as sand or a hardening material (for example, a cement particle) sediments and an undesired water content elevates together with a comparatively light fine substance. Furthermore, a fine aggregate such as sand and water are readily separated in a case where water is singly added in a process for preparation of a filler. On the other hand, a filler according to the present embodiment example is added in such a manner that a water content is principally included in sludge water. In a case where a water content is added in such a manner, a proportion of a water content that separated from a fine aggregate is controlled to be small. Hence, a bleeding rate of a filler is controlled to be a small value, as compared with a filler or the like wherein water is singly added thereto.

Furthermore, it is possible for a filler for construction in the present embodiment to be used for each kind of application as described above, and for each application, it is preferable to select a filler for construction so as to have a practically sufficient strength (compressive strength). It is possible to execute selection of a compressive strength by adjusting an amount of an added hardening material or the like that composes a filler for construction.

For example, it is preferable for a compressive strength of a filler for construction at a material age of 28 days to be less than or equal to 3.5 N/mm². In a case where such a compressive strength is possessed, it is also possible to use a filler for construction as a substitute item for a low-strength concrete other than each kind of application as described above or to be used as a marking or rubble concrete material.

In a case where a filler for construction is used as a marking material, it is more preferable for a compressive strength at a material age of 28 days to be greater than or equal to 1.0 N/mm². Furthermore, a backfill material for an underground railway construction or a cable line construction is drilled again in a case where a need of an operation is subsequently caused again. Accordingly, it is particularly preferable for a compressive strength of a backfill material to be of a practically sufficient strength and a strength capable of drilling again. Specifically, it is particularly preferable for a compressive strength at a material age of 28 days to be less than or equal to 0.5 N/mm².

As having already described above, a fine powder as an admixture material is added to a filler for construction in the present embodiment, and thereby, it is possible to manufacture a filler for construction by using non-concentrated sludge water. Accordingly, it is possible to save labor or energy for conventionally concentrating sludge water. Furthermore, preparation of sludge water is facilitated because it is possible to use such sludge water independently of a concentration thereof.

### PRACTICAL EXAMPLES

Although specific practical examples will be provided and described below, the present invention is not limited to these practical examples.

### Practical Example 1

In the present practical example, a mixing ratio of a hardening material, a fine powder as an admixture material, and sludge water obtained by separating sand and gravel from discharged water provided by washing concrete handling equipment, that are included in a filler for construction according to the present invention, and a further sand was changed to execute evaluations with respect to a flow value, a bleeding rate, appearance, and a compressive strength.

In the present practical example, a blast-furnace cement B-type was used as a hardening material and a pulverized sand with a particle size less than or equal to 10 mm was used as sand. Here, such a pulverized sand was such that one with a particle size greater than 10 mm was removed through a sieve from a pulverized sand obtained by pulverization in a crusher.

A dewatered cake (with a density of 2.65 g/cm³ and a specific surface area of 8500 cm²/g) obtained by applying sludge water to a dewatering machine was used as a fine powder. A concentration of a solid content of sludge water used in any experimental example was 9.8% by mass.

Matters of evaluations executed with respect to a filler for construction obtained in the present practical example will be described below.

A “flow value” was a characteristic value that represented a fluidity of a test object. A flow value was such that a circularly cylindrical container (flow cone) with a diameter of about 80 mm and a height of about 80 mm was filled with a test object, then a bottom surface of the circularly cylindrical container was opened to cause the test object to fall to a floor surface, and subsequently values of diameters of the test object spread on the floor surface with respect to two orthogonal directions were measured. A flow value was a greater value as a test object exhibited a higher fluidity.

A measurement of a “bleeding rate” was executed in conformity with a standard of the Japan Society of Civil Engineers “A method for testing a bleeding rate and a coefficient of expansion of a grouting mortar of a pre-packed concrete (JSCE-1986)”.

A predetermined polyethylene bag (with a diameter of 5 cm and a length greater than or equal to 50 cm) was filled with a filler for construction immediately after mixing in such a manner that air did not mix therein, and was put into a measuring cylinder with 400 cc of water contained therein, wherein an initial volume was obtained by causing a water level to coincide with a surface of the filler for construction and a degree of lowering of the water level was measured by executing a similar measurement after 20 hours of standing thereof, so that a bleeding rate was obtained as a proportion relative to the initial volume.

“Trace” being present in a table means a case where a bleeding water could be confirmed but was a tiny amount in such a manner that it was not possible to calculate a numerical value. That is, being between 0% and 0.1% is meant thereby.

Furthermore, an “appearance evaluation” was such that an evaluation was executed for appearance of a sample that was formed by vertically raising a flow cone filled with the sample when a flow value was measured. Specifically, an evaluation as good was made for a condition that a component included in a filler for construction, such as sand or a powder body, homogeneously or without non-uniformity, spread on an entire circle of a circle that was formed when a flow cone was raised vertically.

Moreover, a “compressive strength” was a result of a compressive strength (with a unit of N/mm²) of a test object that was represented in relation to a hardening material age of the test object. For a measurement thereof, a sample body with a circularly cylindrical shape with a diameter of 50 mm and a height of 100 mm was fabricated and a measurement was executed by an uniaxial compressive strength test machine (an uniaxial test machine (3KN) produced by SHINOHARA SEISAKUSHO CO., LTD) at a time of a predetermined material age (7 days or 28 days).

In the present practical example, respective materials for respective samples with sample Nos. 1-1-1-12 were kneaded to provide composition ratios as illustrated in Table 1 so that fillers for construction were prepared. Table 1 illustrates a mass of each component relative to 1 m³ of a filler for construction wherein a calculation is provided in such a manner that 2% by volume (0.02 m³) of air is included in addition to components as illustrated in the table. Here, the following other practical examples will also be described similarly.

Then, while contents of a dewatered cake and water in a filler for construction were fixed, that of a hardening material was changed between 25-300 kg and accordingly contents of sand and sludge water were changed.

The results are illustrated in Table 1.

TABLE 1

| | | Sample No. | | | |
|---|---|---|---|---|---|
| | | 1-1 | 1-2 | 1-3 | 1-4 |
| Setting agent (kg) | | 25 | 50 | 75 | 100 |
| Sand (kg) | | 581 | 563 | 543 | 519 |
| Dewatered cake (kg) | | 200 | | | |
| Sludge water (kg) | | 560 | 560 | 560 | 564 |
| Water (kg) | | 140 | | | |
| Flow value (mm) | | 290 × 285 | 285 × 280 | 280 × 280 | 285 × 285 |
| Bleeding rate (%) | | 0.3 | 0.3 | 0.1 | 0.2 |
| Appearance | | Good | Good | Good | Good |
| evaluation | | | | | |
| Compressive | 7 days | 0.11 | 0.16 | 0.27 | 0.41 |
| strength | 28 days | 0.26 | 0.44 | 0.73 | 0.90 |
| (N/mm²) | | | | | |
| | | Sample No. | | | |
| | | 1-5 | 1-6 | 1-7 | 1-8 |
| Setting agent (kg) | | 125 | 150 | 175 | 200 |
| Sand (kg) | | 502 | 484 | 458 | 440 |
| Dewatered cake (kg) | | 200 | | | |
| Sludge water (kg) | | 564 | 564 | 568 | 568 |
| Water (kg) | | 140 | | | |
| Flow value (mm) | | 280 × 280 | 270 × 270 | 280 × 280 | 285 × 280 |
| Bleeding rate (%) | | 0.1 | Trace | Trace | Trace |
| Appearance | | Good | Good | Good | Good |
| evaluation | | | | | |
| Compressive | 7 days | 0.58 | 0.74 | 0.97 | 1.29 |
| strength | 28 days | 1.31 | 1.53 | 1.77 | 2.06 |
| (N/mm²) | | | | | |
| | | Sample No. | | | |
| | | 1-9 | 1-10 | 1-11 | 1-12 |
| Setting agent (kg) | | 225 | 250 | 275 | 300 |
| Sand (kg) | | 422 | 396 | 378 | 359 |
| Dewatered cake (kg) | | 200 | | | |
| Sludge water (kg) | | 568 | 572 | 572 | 572 |
| Water (kg) | | 140 | | | |
| Flow value (mm) | | 280 × 280 | 270 × 270 | 265 × 265 | 260 × 260 |
| Bleeding rate (%) | | Trace | Trace | Trace | Trace |
| Appearance | | Good | Good | Good | Good |
| evaluation | | | | | |
| Compressive | 7 days | 1.61 | 1.97 | 2.26 | 2.55 |
| strength | 28 days | 2.33 | 2.61 | 2.84 | 3.12 |
| (N/mm²) | | | | | |

With reference to the results in Table 1, it is possible to find that a compressive strength was increased as a content of the hardening material was increased. Furthermore, any sample exhibited a high flow value and a low bleeding rate and appearance of any one was good.

From the above results, it was possible to confirm that a filler for construction in the present invention was such that even a filler for construction manufactured by using non-concentrated sludge water had a sufficient performance.

Then, it was possible to confirm that it was possible for a filler for construction as illustrated in the present practical example to save labor or energy for conventionally concentrating sludge water because non-concentrated sludge water was used.

### Practical Example 2

In the present practical example, a study was executed with respect to a characteristic change of a filler amount for construction in a case where containment ratios of sand and a fine powder as an admixture material were changed.

Used materials and executed test methods were similar to those of Practical Example 1.

Compositions in respective experimental examples and evaluation results are illustrated in Table 2.

TABLE 2

Sample No.
2-1

| | |
|---|---|
| 2-1-1 | 2-1-2 |

| | |
|---|---|
| Setting agent (kg/m³) | 25 |

| | | |
|---|---|---|
| Sand (kg) | 95 | 0 |
| Sand (kg/m³) | 1170 | 0 |
| Dewatered cake (%) | 5 | 100 |
| Dewatered cake (kg/m³) | 55 | 578 |

| | |
|---|---|
| Sludge water (kg/m³) | 440 |

| Water (kg/m³) | | 12 | 280 |
|---|---|---|---|
| Flow value (mm) | | 275 × 275 | 300 × 295 |
| Bleeding rate (%) | | 0.5 | 0 |
| Appearance evaluation | | Good | Good |
| Compressive strength | 7 days | 0.07 | 0.15 |
| (N/mm²) | 28 days | 0.22 | 0.37 |

| | | Sample No. | | |
|---|---|---|---|---|
| | | 2-2 | | |
| | | 2-2-1 | 2-2-2 | 2-2-3 |
| Setting agent (kg/m³) | | 50 | | |
| Sand (kg) | | 95 | 50 | 0 |
| Sand (kg/m³) | | 1155 | 473 | 0 |
| Dewatered cake (%) | | 5 | 50 | 100 |
| Dewatered cake (kg/m³) | | 53 | 424 | 562 |
| Sludge water (kg/m³) | | 440 | | |
| Water (kg/m³) | | 12 | 134 | 280 |
| Flow value (mm) | | 270 × 270 | 285 × 280 | 300 × 300 |
| Bleeding rate (%) | | 0.4 | 0.2 | 0 |
| Appearance evaluation | | Good | Good | Good |
| Compressive strength | 7 days | 0.12 | 0.12 | 0.23 |
| (N/mm²) | 28 days | 0.40 | 0.31 | 0.51 |

Sample No.
2-3

| | |
|---|---|
| 2-3-1 | 2-3-2 |

| | |
|---|---|
| Setting agent (kg/m³) | 75 |

| | | |
|---|---|---|
| Sand (kg) | 95 | 0 |
| Sand (kg/m³) | 1135 | 0 |
| Dewatered cake (%) | 5 | 100 |
| Dewatered cake (kg/m³) | 52 | 505 |

| | |
|---|---|
| Sludge water (kg/m³) | 440 |

| Water (kg/m³) | | 12 | 300 |
|---|---|---|---|
| Flow value (mm) | | 265 × 260 | 310 × 310 |
| Bleeding rate (%) | | 0.3 | 0 |
| Appearance evaluation | | Good | Good |
| Compressive strength | 7 days | 0.21 | 0.33 |
| (N/mm²) | 28 days | 0.67 | 0.80 |

| | | Sample No. | | |
|---|---|---|---|---|
| | | 2-4 | | |
| | | 2-4-1 | 2-4-2 | 2-4-3 |
| Setting agent (kg/m³) | | 100 | | |
| Sand (kg) | | 95 | 50 | 0 |
| Sand (kg/m³) | | 1120 | 444 | 0 |
| Dewatered cake (%) | | 5 | 50 | 100 |
| Dewatered cake (kg/m³) | | 51 | 398 | 489 |
| Sludge water (kg/m³) | | 440 | | |
| Water (kg/m³) | | 12 | 144 | 300 |
| Flow value (mm) | | 260 × 260 | 275 × 270 | 305 × 300 |
| Bleeding rate (%) | | 0.3 | 0.1 | 0 |
| Appearance evaluation | | Good | Good | Good |
| Compressive strength | 7 days | 0.39 | 0.42 | 0.47 |
| (N/mm²) | 28 days | 0.82 | 0.92 | 0.98 |

Sample No.
2-5

| | |
|---|---|
| 2-5-1 | 2-5-2 |

| | |
|---|---|
| Setting agent (kg/m³) | 125 |

| | | |
|---|---|---|
| Sand (kg) | 95 | 0 |
| Sand (kg/m³) | 1102 | 0 |
| Dewatered cake (%) | 5 | 100 |
| Dewatered cake (kg/m³) | 51 | 434 |

| | |
|---|---|
| Sludge water (kg/m³) | 440 |

| Water (kg/m³) | | 12 | 320 |
|---|---|---|---|
| Flow value (mm) | | 270 × 270 | 290 × 290 |
| Bleeding rate (%) | | 0.2 | 0 |
| Appearance evaluation | | Good | Good |
| Compressive strength | 7 days | 0.52 | 0.65 |
| (N/mm²) | 28 days | 1.26 | 1.39 |

| | | Sample No. | | |
|---|---|---|---|---|
| | | 2-6 | | |
| | | 2-6-1 | 2-6-2 | 2-6-3 |
| Setting agent (kg/m³) | | 150 | | |
| Sand (kg) | | 95 | 50 | 0 |
| Sand (kg/m³) | | 1087 | 416 | 0 |
| Dewatered cake (%) | | 5 | 50 | 100 |
| Dewatered cake (kg/m³) | | 50 | 342 | 418 |
| Sludge water (kg/m³) | | 440 | | |
| Water (kg/m³) | | 12 | 154 | 320 |
| Flow value (mm) | | 260 × 260 | 280 × 280 | 310 × 305 |
| Bleeding rate (%) | | 0.1 | Trace | 0 |
| Appearance evaluation | | Good | Good | Good |
| Compressive strength | 7 days | 0.68 | 0.74 | 0.81 |
| (N/mm²) | 28 days | 1.48 | 1.55 | 1.6 |

Sample No.
2-7

| | |
|---|---|
| 2-7-1 | 2-7-2 |

| | |
|---|---|
| Setting agent (kg/m³) | 175 |

| | | |
|---|---|---|
| Sand (kg) | 95 | 0 |
| Sand (kg/m³) | 1067 | 0 |
| Dewatered cake (%) | 5 | 100 |
| Dewatered cake (kg/m³) | 50 | 360 |

| | |
|---|---|
| Sludge water (kg/m³) | 440 |

| Water (kg/m³) | | 12 | 340 |
|---|---|---|---|
| Flow value (mm) | | 275 × 270 | 300 × 300 |
| Bleeding rate (%) | | 0.1 | 0 |
| Appearance evaluation | | Good | Good |
| Compressive strength | 7 days | 0.91 | 1.05 |
| (N/mm²) | 28 days | 1.70 | 1.84 |

| | | Sample No. | | |
|---|---|---|---|---|
| | | 2-8 | | |
| | | 2-8-1 | 2-8-2 | 2-8-3 |
| Setting agent (kg/m³) | | 200 | | |
| Sand (kg) | | 95 | 50 | 0 |
| Sand (kg/m³) | | 1049 | 385 | 0 |
| Dewatered cake (%) | | 5 | 50 | 100 |
| Dewatered cake (kg/m³) | | 50 | 347 | 345 |
| Sludge water (kg/m³) | | 440 | | |
| Water (kg/m³) | | 12 | 164 | 340 |
| Flow value (mm) | | 255 × 255 | 285 × 285 | 300 × 295 |
| Bleeding rate (%) | | 0 | Trace | 0 |
| Appearance evaluation | | Good | Good | Good |
| Compressive strength | 7 days | 1.22 | 1.28 | 1.35 |
| (N/mm²) | 28 days | 1.98 | 2.07 | 2.13 |

Sample No.
2-9

| | | 2-9-1 | 2-9-2 |
|---|---|---|---|
| Setting agent (kg/m³) | | 225 | |
| Sand (kg) | | 95 | 0 |
| Sand (kg/m³) | | 1034 | 0 |
| Dewatered cake (%) | | 5 | 100 |
| Dewatered cake (kg/m³) | | 48 | 289 |
| Sludge water (kg/m³) | | 440 | |
| Water (kg/m³) | | 12 | 360 |
| Flow value (mm) | | 260 × 260 | 310 × 305 |
| Bleeding rate (%) | | 0 | 0 |
| Appearance evaluation | | Good | Good |
| Compressive strength | 7 days | 1.53 | 1.69 |
| (N/mm²) | 28 days | 2.23 | 2.40 |

Sample No.
2-10

| | |
|---|---|
| 2-10-1 | 2-10-2 |

| | |
|---|---|
| Setting agent (kg/m³) | 250 |

| | | |
|---|---|---|
| Sand (kg) | 95 | 0 |
| Sand (kg/m³) | 1016 | 0 |
| Dewatered cake (%) | 5 | 100 |
| Dewatered cake (kg/m³) | 48 | 273 |

| | |
|---|---|
| Sludge water (kg/m³) | 440 |

| Water (kg/m³) | | 12 | 360 |
|---|---|---|---|
| Flow value (mm) | | 245 × 245 | 290 × 285 |
| Bleeding rate (%) | | 0 | 0 |
| Appearance evaluation | | Good | Good |
| Compressive strength | 7 days | 1.91 | 2.07 |
| (N/mm²) | 28 days | 2.50 | 2.72 |

Sample No.
2-11

| | |
|---|---|
| 2-11-1 | 2-11-2 |

| | |
|---|---|
| Setting agent (kg/m³) | 275 |

| | | |
|---|---|---|
| Sand (kg) | 95 | 0 |
| Sand (kg/m³) | 1001 | 0 |
| Dewatered cake (%) | 5 | 100 |
| Dewatered cake (kg/m³) | 46 | 218 |

| | |
|---|---|
| Sludge water (kg/m³) | 440 |

| Water (kg/m³) | | 12 | 380 |
|---|---|---|---|
| Flow value (mm) | | 240 × 235 | 295 × 295 |
| Bleeding rate (%) | | 0 | 0 |
| Appearance evaluation | | Good | Good |
| Compressive strength | 7 days | 2.17 | 2.33 |
| (N/mm²) | 28 days | 2.72 | 2.93 |

Sample No.
2-12

| | |
|---|---|
| 2-12-1 | 2-12-2 |

| | |
|---|---|
| Setting agent (kg/m³) | 300 |

| | | |
|---|---|---|
| Sand (kg) | 95 | 0 |
| Sand (kg/m³) | 981 | 0 |
| Dewatered cake (%) | 5 | 100 |
| Dewatered cake (kg/m³) | 46 | 200 |

| | |
|---|---|
| Sludge water (kg/m³) | 440 |

| Water (kg/m³) | | 12 | 380 |
|---|---|---|---|
| Flow value (mm) | | 240 × 240 | 390 × 285 |
| Bleeding rate (%) | | 0 | 0 |
| Appearance evaluation | | Good | Good |
| Compressive strength | 7 days | 2.46 | 2.66 |
| (N/mm²) | 28 days | 3.01 | 3.24 |

In the present practical example, a proportion of occupying sand and fine powder in a total volume of sand and a fine powder as an admixture material was changed in each experimental example as illustrated in Table 2.

For example, for samples 2-2-1-2-2-3 in sample No. 2-2, a volume amount of sand was changed within a range of 95-0% by volume with respect to a total volume of sand and a fine powder, and accordingly, that of a fine powder was changed within a range of 5-100% by volume.

For an experimental example with an identical content of a hardening material, it was possible to confirm that a low value was increased as a content of a fine powder was increased. Furthermore, it was possible to confirm that any experimental example exhibited good results with respect to a flow value, a bleeding rate, an appearance evaluation, and a compressive strength.

### Practical Example 3

In the present practical example, a study was executed by using each of a fly-ash fine powder (with a density of 2.25 g/cm² and a specific surface area of 4150 cm²/g), a blast-furnace slag fine powder (with a density of 2.89 g/cm³ and a specific surface area of 4170 cm²/g), an electric furnace slag fine powder (with a density of 3.10 g/cm²), and a sludge/garbage incineration ash (with a density of 2.67 g/cm³) for a fine powder as an admixture material, instead of a dewatered cake that was obtained when a sludge water was manufactured.

Execution was provided similarly to Practical Example 1 except that the material as described above was used as a fine powder.

Compositions in respective experimental examples and evaluation results are illustrated in Table 3.

With reference to this, it was possible to confirm that any experimental example exhibited good results with respect to a flow value, a bleeding rate, an appearance evaluation, and a compressive strength.

That is, from this result, it was possible to confirm that a fine powder as an admixture material was not limited to a dewatered cake but it was possible to use each kind of fine powder.

TABLE 3

| | | Sample No. | | |
|---|---|---|---|---|
| | | 3-1 | | |
| | | 3-1-1 | 3-1-2 | 3-1-3 |
| Setting agent (kg) | | 50 | | |
| Sand (kg) | | 95 | 50 | 0 |
| Sand (kg/m³) | | 1157 | 506 | 0 |
| Fine powder (%) | | 5 | 50 | 100 |
| Fine powder (kg/m³) | | 81 | 501 | 750 |
| Kind of fine powder | | Fly-ash fine powder | | |
| Sludge water (kg) | | 440 | | |
| Water (kg) | | 11 | 104 | 220 |
| Flow value (mm) | | 250 × 250 | 270 × 270 | 300 × 300 |
| Bleeding rate (%) | | 0.5 | 0.3 | 0 |
| Appearance evaluation | | Good | Good | Good |
| Compressive strength | 7 days | 0.10 | 0.18 | 0.25 |
| (N/mm²) | 28 days | 0.41 | 0.49 | 0.57 |
| | | Sample No. | | |
| | | 3-2 | | |
| | | 3-2-1 | 3-2-2 | 3-2-3 |
| Setting agent (kg) | | 100 | | |
| Sand (kg) | | 95 | 50 | 0 |
| Sand (kg/m³) | | 1118 | 466 | 0 |
| Fine powder (%) | | 5 | 50 | 100 |
| Fine powder (kg/m³) | | 78 | 462 | 861 |
| Kind of fine powder | | Fly-ash fine powder | | |
| Sludge water (kg) | | 440 | | |
| Water (kg) | | 13 | 123 | 260 |
| Flow value (mm) | | 260 × 255 | 280 × 275 | 300 × 290 |
| Bleeding rate (%) | | 0.4 | 0.2 | 0 |
| Appearance evaluation | | Good | Good | Good |
| Compressive strength | 7 days | 0.37 | 0.44 | 0.50 |
| (N/mm²) | 28 days | 0.80 | 0.91 | 1.01 |
| | | Sample No. | | |
| | | 3-3 | | |
| | | 3-3-1 | 3-3-2 | 3-3-3 |
| Setting agent (kg) | | 50 | | |
| Sand (kg) | | 95 | 50 | 0 |
| Sand (kg/m³) | | 1157 | 506 | 0 |
| Fine powder (%) | | 5 | 50 | 100 |
| Fine powder (kg/m³) | | 62 | 517 | 791 |
| Kind of fine powder | | Blast-furnace slag fine | | |
| | | powder | | |
| Sludge water (kg) | | 440 | | |
| Water (kg) | | 11 | 104 | 220 |
| Flow value (mm) | | 265 × 260 | 280 × 280 | 300 × 300 |
| Bleeding rate (%) | | 0.4 | 0.3 | 0 |
| Appearance evaluation | | Good | Good | Good |
| Compressive strength | 7 days | 0.19 | 0.26 | 0.35 |
| (N/mm²) | 28 days | 0.58 | 0.72 | 0.83 |
| | | Sample No. | | |
| | | 3-4 | | |
| | | 3-4-1 | 3-4-2 | 3-4-3 |
| Setting agent (kg) | | 100 | | |
| Sand (kg) | | 95 | 50 | 0 |
| Sand (kg/m³) | | 1153 | 466 | 0 |
| Fine powder (%) | | 5 | 50 | 100 |
| Fine powder (kg/m³) | | 62 | 477 | 699 |
| Kind of fine powder | | Blast-furnace slag fine | | |
| | | powder | | |
| Sludge water (kg) | | 440 | | |
| Water (kg) | | 13 | 123 | 260 |
| Flow value (mm) | | 265 × 260 | 290 × 290 | 300 × 290 |
| Bleeding rate (%) | | 0.3 | 0.1 | 0 |
| Appearance evaluation | | Good | Good | Good |
| Compressive strength | 7 days | 0.43 | 0.50 | 0.55 |
| (N/mm²) | 28 days | 0.82 | 1.04 | 1.13 |
| | | Sample No. | | |
| | | 3-5 | | |
| | | 3-5-1 | 3-5-2 | 3-5-3 |
| Setting agent (kg) | | 50 | | |
| Sand (kg) | | 95 | 50 | 0 |
| Sand (kg/m³) | | 1157 | 506 | 0 |
| Fine powder (%) | | 5 | 50 | 100 |
| Fine powder (kg/m³) | | 62 | 529 | 791 |
| Kind of fine powder | | Electric furnace slag fine | | |
| | | powder | | |
| Sludge water (kg) | | 440 | | |
| Water (kg) | | 11 | 104 | 220 |
| Flow value (mm) | | 270 × 270 | 280 × 280 | 310 × 300 |
| Bleeding rate (%) | | 0.3 | 0.2 | 0 |
| Appearance evaluation | | Good | Good | Good |
| Compressive strength | 7 days | 0.08 | 0.19 | 0.27 |
| (N/mm²) | 28 days | 0.39 | 0.48 | 0.58 |
| | | Sample No. | | |
| | | 3-6 | | |
| | | 3-6-1 | 3-6-2 | 3-6-3 |
| Setting agent (kg) | | 100 | | |
| Sand (kg) | | 95 | 50 | 0 |
| Sand (kg/m³) | | 1153 | 466 | 0 |
| Fine powder (%) | | 5 | 50 | 100 |
| Fine powder (kg/m³) | | 73 | 488 | 821 |
| Kind of fine powder | | Electric furnace slag fine | | |
| | | powder | | |
| Sludge water (kg) | | 440 | | |
| Water (kg) | | 13 | 123 | 260 |
| Flow value (mm) | | 250 × 250 | 265 × 260 | 290 × 290 |
| Bleeding rate (%) | | 0.2 | 0.1 | 0 |
| Appearance evaluation | | Good | Good | Good |
| Compressive strength | 7 days | 0.40 | 0.49 | 0.53 |
| (N/mm²) | 28 days | 0.77 | 0.93 | 1.04 |
| | | Sample No. | | |
| | | 3-7 | | |
| | | 3-7-1 | 3-7-2 | 3-7-3 |
| Setting agent (kg) | | 50 | | |
| Sand (kg) | | 95 | 50 | 0 |
| Sand (kg/m³) | | 1157 | 506 | 0 |
| Fine powder (%) | | 5 | 50 | 100 |
| Fine powder (kg/m³) | | 70 | 598 | 894 |
| Kind of fine powder | | Sludge/garbage | | |
| | | incineration ash | | |
| Sludge water (kg) | | 440 | | |
| Water (kg) | | 11 | 104 | 220 |
| Flow value (mm) | | 270 × 270 | 280 × 280 | 310 × 310 |
| Bleeding rate (%) | | 0.3 | 0.2 | 0 |
| Appearance evaluation | | Good | Good | Good |
| Compressive strength | 7 days | 0.07 | 0.17 | 0.26 |
| (N/mm²) | 28 days | 0.40 | 0.50 | 0.58 |
| | | Sample No. | | |
| | | 3-8 | | |
| | | 3-8-1 | 3-8-2 | 3-8-3 |
| Setting agent (kg) | | 100 | | |
| Sand (kg) | | 95 | 50 | 0 |
| Sand (kg/m³) | | 1153 | 446 | 0 |
| Fine powder (%) | | 5 | 50 | 100 |
| Fine powder (kg/m³) | | 70 | 551 | 790 |
| Kind of fine powder | | Sludge/garbage | | |
| | | incineration ash | | |
| Sludge water (kg) | | 440 | | |
| Water (kg) | | 13 | 123 | 260 |
| Flow value (mm) | | 250 × 250 | 270 × 270 | 290 × 290 |
| Bleeding rate (%) | | 0.2 | Trace | 0 |
| Appearance evaluation | | Good | Good | Good |
| Compressive strength | 7 days | 0.37 | 0.55 | 0.63 |
| (N/mm²) | 28 days | 0.75 | 0.87 | 1.02 |

### Practical Example 4

In the present practical example, a hexavalent chromium reducing agent was added to each sample (each experimental example) in Practical Example 1 so that a study was executed with respect to an effect of reducing an amount of eluted hexavalent chromium.

For a hexavalent chromium reducing agent, a salt of ferrous sulfate heptahydrate was used and an amount of addition thereof was changed so that an examination for an amount of eluted hexavalent chromium was executed with respect to a filler for construction before hardening (immediately after kneading) thereof. A salt of ferrous sulfate heptahydrate that was a hexavalent chromium reducing agent was kneaded together with other materials when a filler for construction was kneaded.

An examination for an amount of eluted hexavalent chromium was executed in accordance with the following procedures.

(a) 10 g of a kneaded filler for construction was put into a pure water with a volume ten times as large as that of such a filler for construction (at room temperature) and shaken by a shaking machine for 6 hours.

(b) After shaking thereof, filtration was executed to separate the filler for construction from an elution fluid (extraction fluid).

(c) After a reagent set for a water quality measurement for hexavalent chromium (produced by Kyoritsu Chemical-Check Lab., Corp., model: LR-Cr⁶⁺) was added to 25 ml of the elution fluid, sodium chloride was added and mixed thereto.

(d) A process for concentration by 12.5 times was executed by using a solid phase pretreatment column (solid phase packed column) (produced by Hitachi High-Technologies Corporation, model: NOBIAS RP-OD1E).

(e) A concentration of hexavalent chromium in a solution obtained in process (d) was measured in accordance with an absorptiometry (wherein a measurement was executed by using Digital Pack Test (registered trademark) produced by Kyoritsu Chemical-Check Lab., Corp).

The results are illustrated in Table 4.

Here, an amount of an added hexavalent chromium reducing agent in the table means an amount of addition relative to 1 m³ of a filler for construction. That is, a notation of 0.1 kg/m³ with respect to an amount of an added hexavalent chromium reducing agent means that 0.1 kg of a hexavalent chromium reducing agent was added to 1 m³ of a filler for construction. Then, an evaluation was executed each for a case where 0.1 kg/m³, 0.25 kg/m³, and 0.5 kg/m³ of a hexavalent chromium reducing agent was added to each sample.

Furthermore, a unit of a detection value in the table in a case where a hexavalent chromium reducing agent was added is mg/L (wherein, for example, a detection value for hexavalent chromium in a case of no addition of a hexavalent chromium reducing agent in sample No. 1-1 means 0.037 mg/L) and an amount of hexavalent chromium in a detection fluid (extraction fluid) after concentration in the examination described above is meant thereby. Hence, an amount of hexavalent chromium eluted from 10 g of a practical filler for construction to 1 liter of a pure water with a volume 10 times thereof is one-12.5th of such a value.

TABLE 4

| | | Sample No. | | | |
|---|---|---|---|---|---|
| | | 1-1 | 1-2 | 1-3 | 1-4 |
| Setting agent (kg) | | 25 | 50 | 75 | 100 |
| Sand (kg) | | 581 | 563 | 543 | 519 |
| Dewatered cake (kg) | | 200 | | | |
| Sludge water (kg) | | 560 | 560 | 560 | 564 |
| Water (kg) | | 140 | | | |
| Hexa- | No | 0.037 | 0.042 | 0.047 | 0.051 |
| valent | addition | | | | |
| chromium | 0.1 kg/m³ | 0.027 | 0.029 | 0.031 | 0.033 |
| reducing | 0.25 kg/m³ | 0.007 | 0.010 | 0.013 | 0.015 |
| agent | 0.5 kg/m³ | 0.005 | 0.005 | 0.005 | 0.005 |
| | | or less | or less | or less | or less |
| | | Sample No. | | | |
| | | 1-5 | 1-6 | 1-7 | 1-8 |
| Setting agent (kg) | | 125 | 150 | 175 | 200 |
| Sand (kg) | | 502 | 484 | 458 | 440 |
| Dewatered cake (kg) | | 200 | | | |
| Sludge water (kg) | | 564 | 564 | 568 | 568 |
| Water (kg) | | 140 | | | |
| Hexa- | No | 0.053 | 0.053 | 0.055 | 0.058 |
| valent | addition | | | | |
| chromium | 0.1 kg/m³ | 0.034 | 0.036 | 0.038 | 0.041 |
| reducing | 0.25 kg/m³ | 0.018 | 0.021 | 0.023 | 0.025 |
| agent | 0.5 kg/m³ | 0.005 | 0.005 | 0.006 | 0.008 |
| | | or less | or less | | |
| | | Sample No. | | | |
| | | 1-9 | 1-10 | 1-11 | 1-12 |
| Setting agent (kg) | | 225 | 250 | 275 | 300 |
| Sand (kg) | | 422 | 396 | 378 | 359 |
| Dewatered cake (kg) | | 200 | | | |
| Sludge water (kg) | | 568 | 572 | 572 | 572 |
| Water (kg) | | 140 | | | |
| Hexa- | No | 0.058 | 0.059 | 0.061 | 0.064 |
| valent | addition | | | | |
| chromium | 0.1 kg/m³ | 0.045 | 0.049 | 0.053 | 0.059 |
| reducing | 0.25 kg/m³ | 0.028 | 0.032 | 0.035 | 0.039 |
| agent | 0.5 kg/m³ | 0.011 | 0.013 | 0.016 | 0.020 |

With reference to Table 4, it is possible to find that an amount of eluted hexavalent chromium was reduced in any sample as an amount of an added hexavalent chromium reducing agent was increased. That is, it was possible to confirm that a hexavalent chromium reducing agent had an effect of suppressing elution of hexavalent chromium from a filler for construction.

Furthermore, it is possible to find that sample Nos. 1-1-1-6 were less than or equal to a detection limit of the present measurement method and exhibited an extremely high effect of reducing hexavalent chromium in a case where an amount of an added hexavalent chromium reducing agent was increased to 0.5 kg/m³.

### Practical Example 5

In the present practical example, a hexavalent chromium reducing agent was added to a part of the samples in Practical Example 3 so that a study was executed with respect to an effect of reducing an amount of eluted hexavalent chromium.

For a hexavalent chromium reducing agent, a salt of ferrous sulfate heptahydrate was used similarly to Practical Example 4. Furthermore, an examination for an amount of eluted hexavalent chromium was also executed by a method as illustrated in Practical Example 4 and a notation method was also similar thereto.

The results are illustrated in Table 5.

TABLE 5

| | | Sample No. | | | |
|---|---|---|---|---|---|
| | | 3-1-2 | 3-2-2 | 3-3-2 | 3-4-2 |
| Setting agent (kg) | | 50 | 100 | 50 | 100 |
| Sand (kg) | | 50 | 50 | 50 | 50 |
| Sand (kg/m³) | | 506 | 466 | 506 | 466 |
| Fine powder (%) | | 50 | 50 | 50 | 50 |
| Fine powder (kg/m³) | | 501 | 462 | 517 | 477 |
| Kind of fine powder | | Fly-ash fine | | Blast-furnace | |
| | | powder | | slag fine powder | |
| Sludge water (kg) | | 440 | | | |
| Water (kg) | | 104 | 123 | 104 | 123 |
| Hexa- | No | 0.040 | 0.047 | 0.042 | 0.049 |
| valent | addition | | | | |
| chromium | 0.1 kg/m³ | 0.029 | 0.032 | 0.030 | 0.034 |
| reducing | 0.25 kg/m³ | 0.009 | 0.013 | 0.011 | 0.015 |
| agent | 0.5 kg/m³ | 0.005 | 0.005 | 0.005 | 0.005 |
| | | or less | or less | or less | or less |
| | | Sample No. | | | |
| | | 3-5-2 | 3-6-2 | 3-7-2 | 3-8-2 |
| Setting agent (kg) | | 50 | 100 | 50 | 100 |
| Sand (kg) | | 50 | 50 | 50 | 50 |
| Sand (kg/m³) | | 506 | 466 | 506 | 466 |
| Fine powder (%) | | 50 | 50 | 50 | 50 |
| Fine powder (kg/m³) | | 529 | 488 | 598 | 551 |
| Kind of fine powder | | Electric furnace | | Sludge/garbage | |
| | | slag fine powder | | incineration ash | |
| Sludge water (kg) | | 440 | | | |
| Water (kg) | | 104 | 123 | 104 | 123 |
| Hexa- | No | 0.039 | 0.047 | 0.038 | 0.049 |
| valent | addition | | | | |
| chromium | 0.1 kg/m³ | 0.029 | 0.035 | 0.028 | 0.034 |
| reducing | 0.25 kg/m³ | 0.011 | 0.012 | 0.008 | 0.012 |
| agent | 0.5 kg/m³ | 0.005 | 0.005 | 0.005 | 0.005 |
| | | or less | or less | or less | or less |

With reference to Table 5, it was possible to confirm that an amount of eluted hexavalent chromium was reduced as an amount of an added hexavalent chromium reducing agent was increased, similarly to the results of Practical Example 4.

Furthermore, it was possible to confirm that a hexavalent chromium reducing agent exerted an effect thereof in any case although each kind of fine powder as illustrated in Table 5 was used as a fine powder in the present practical example instead of a dewatered cake.

Although a filler for construction has been described by a practical example, the present invention is not limited to the practical example as described above or the like and a variety of alterations and modifications are possible within the scope of the present invention.

The present international application claims priority based on Japanese Patent Application No. 2012-176190 filed on Aug. 8, 2012 before the Japan Patent Office, and the entire contents of Japanese Patent Application No. 2012-176190 are incorporated by reference in the present international application.

### EXPLANATION OF LETTERS OR NUMERALS

18 . . . filler

1. A filler for construction, comprising:
a hardening material;
a fine powder; and
sludge water obtained by separating sand and gravel from discharged water obtained from washing concrete handling equipment.

2. The filler for construction as claimed in claim 1, wherein a solid component concentration of the sludge water is less than 10 mass %.

3. The filler for construction as claimed in claim 1, wherein the fine powder is selected from the group consisting of a dewatered cake obtained by applying sludge water to a dewatering machine, a fly-ash fine powder, a blast-furnace slag fine powder, an electric furnace slag fine powder, a garbage incineration ash, a sludge incineration ash, and any combination thereof.

4. The filler for construction as claimed in claim 1, wherein a compressive strength at a material age of 28 days is 3.5 N/mm² or less.

5. The filler for construction as claimed in claim 1, further comprising:
a hexavalent chromium reducing agent.
